(19) United States
(12) Patent Application Publication
(10) Pub. No.: US 2019/0179882 A1
(43) Pub. Date: Jun. 13, 2019

(54) System for Providing Portable Interactive Document

(71) Applicant: David B. Weiss, New York, NY (US)

(72) Inventor: David B. Weiss, New York, NY (US)

(21) Appl. No.: 16/125,564

(22) Filed: Sep. 7, 2018

Related U.S. Application Data
(60) Provisional application No. 62/555,082, filed on Sep. 7, 2017.

(51) Int. Cl. G06F 17/24; G06F 17/21

(52) U.S. Cl. CPC G06F 17/24; G06F 17/218; G06F 17/212

(57) ABSTRACT

A document generation, compilation/packaging, distribution, rendering, printing, display, and interaction process whereby one or more related files are generated with dynamic and/or interactive links to themselves, each other, and/or additional offline and/or online data, files, and/or sources, compiled/packaged together into one or more cohesive, portable, and optionally read-only files to be distributed and rendered by an executable, program, or run-time engine for portable and uniform display and printing on a variety of computer operating systems as a portable interactive document (PID) which expressly preserves the dynamic and/or interactive links and facilitates their functionality and related user experience for the PID consumer. The PID can include files in its package such as, but not limited to, HTML, HTML5, JSON, SGML, and XML and can replicate inside a portable document an interactive user experience similar, but not limited to, that common to web browsing.

### BACKGROUND

The present applicaiton relates to methods and systems for generating interactive documents.

Multiple read-write document formats exist for the creation and distribution of content and media such as .DOC and .XLS which allow for editing and non-uniform rendering. Additional document formats exist which allow for read-only access and portable and uniform display and printing on a variety of computer operating systems, most notably Adobe's .PDF. Subsequent to these document formats, the World Wide Web was created utilizing HTML documents which allowed for dynamic and interactive online browsing and hypertext linking amongst multiple HTML documents, then becoming more functional and interactive with the advent of HTML5. However, HTML and HTML5 have non-uniform rendering, display, and printing with usually limited offline access, and both the read-write and read-only document formats have very limited, if any, provision for the dynamic and interactive links and functionality common to modern web browsing. While the .PDF has become prolific for both online and printed publishing and distribution, it lacks the data and interactivity taken for granted in purely online publishing (which often exists in parallel on the web with the offline .PDF). A new portable interactive documet (PID) format is called for which leverages online publishing media to preserve uniform rendering, printing, and display, while also providing portable dynamic interactivity even while offline.

### SUMMARY

1. The present applicaiton provides related documents and associated data files, such as, but not limited to, HTML, HTML5, JSON, SGML, and XML for online publishing such as on the web are persisted into a data store structure (e.g., directories, folders).
2. Optionally, offline read-write and read-only documents and associated data files such as, but not limited to, .DOC, .XLS, .CSV, and .PDF are saved in online file formats such as, but not limited to, HTML or HTML5 persisted into a data store structure (e.g., directories, folders).
3. Optionally, online publishing files are persisted directly into an online data store structure (e.g., web server).
4. A .PID creator parses through the data store structure reading each file to compile/package all the files while maintaining their relationships and dynamic and interactive links and functionality to generate one or more read-only .PID files.
5. Optionally, a .PID can be generated as read-write, password-protected read-only, and/or password-protected read-write.
6. Optionally, a .PID can be generated as an encrypted .PID with an encryption key.
7. The .PID can be accessed and opened on any computing device where the .PID executable, program, or run-time engine is installed via association of the .PID extension and file type with the .PID executable, program, or run-time engine.
8. Optionally, the PID executable, program, or run-time engine can be automatically installed on any computing device the first time a .PID is opened on that device.
9. The .PID can be distributed by any traditional means such as, but not limited to, downloading, e-mail, and USB drive so long as the .PID is able to be accessed and opened on a computing device with the PID executable, program, or run-time engine installed.
10. The .PID executable, program, or run-time engine is designed to render an online web browsing experience based on common standards (e.g., HTML5) and can be proprietary, open-source, or commercially available (e.g., Paragon, Chromium, Electron, OpenFin).
11. The .PID executable, program, or run-time engine can be created for a variety of computing devices and operating systems so that the .PID is made compatible and portable across multiple computing platforms and operating systems.
12. Optionally, the .PID executable, program, or run-time engine can use a manually entered or persisted encryption key to access and open an encrypted .PID.
13. Optionally, the .PID executable, program, or run-time engine can use a manually entered or persisted password to access and open a .PID in whole or in part.
14. Optionally, the .PID executable, program, or run-time engine can use a manually entered or persisted encryption key or password to access and open a .PID in whole or in part as read-write.
15. The .PID executable, program, or run-time engine opens a .PID file or files and renders it for uniform display and printing on any computing device on which it's installed.
16. The .PID executable, program, or run-time engine renders a .PID file or files so as to maintain and recreate all of their original relationships and dynamic and interactive links and functionality intrinsically in the display and thereby portably provide a dynamic interactive web browsing user experience while offline (i.e., as if the original precompiled related documents and associated data files were online) such as, but not limited to, hypertext linking, animation, document collapse/expand, zoom in/out, popup and sessionless windows, and data entry, filtering, and manipulation.
17. Optionally, the .PID can include online-only dynamic interactivity and linking functionality embedded in the original source documents and data files which remains dormant until the .PID executable, program, or run-time engine establishes a network and/or internet connection such as, but not limited to, online hypertext, URL, and additional .PID links, live data, electronic communications and messaging, and content access and usage metrics and tracking.
18. Optionally, the .PID executable, program, or run-time engine can cache activation of online-only dynamic interactivity and linking functionality embedded in the original source documents and data files until such time as it established a network and/or internet connection.
19. Optionally, the .PID executable, program, or run-time engine can facilitate distribution of .PIDs when it establishes a network and/or internet connection.
20. Optionally, the .PID executable, program, or run-time engine can also support applications such as, but not limited to, HTML5 and facilitate data interchange, interaction, and interoperability and between .PIDs and those applications.

### BRIEF DESCRIPTION OF THE DRAWINGS

FIG. 1 is a block diagram showing interrelationship between file content in a portable interative document formant.

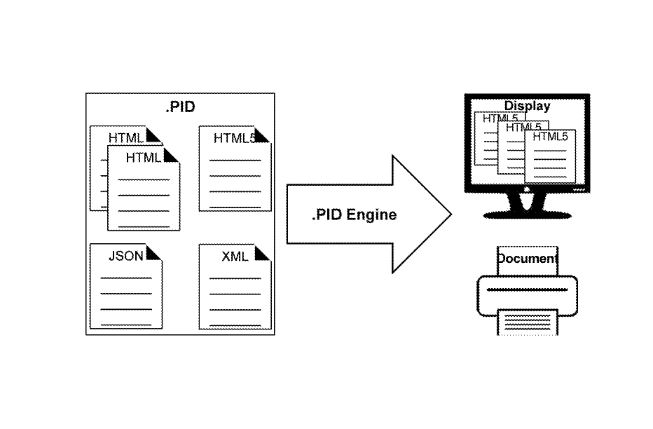

### DETAILED DESCRIPTION

Read-write document formats such as .DOC and .XLS offer limited read-only protection, multiple file packaging, and uniform rendering, display, and printing which read-only document formats such as the .PDF solve, but none of these offer the dynamic interactivity, data driven, and rich functionality of online web browsing. Online web browsing offers limited read-only protection, multiple file packaging, and uniform rendering, display, and printing and is inherently not designed offline or portable usage. The .PID is the first document format to flexibly combine the best of the offline read-only file and online dynamic interactive web browsing user experience in a truly portable file with uniform rendering, printing, and display.

### Usage

Content creators and editorial staff can author their content directly in online formats such as HTML or HTML5, or indirectly in offline formats such as .DOC and .PDF and then save them as HTML, and then compile these multiple files, optionally with data (e.g., JSON, XML), into a single portable read-only .PID package file. The file is then distributed to the content consumer through any means (e.g., download, e-mail) for rendering via the .PID engine installed on their computing device (or optionally distributed via the .PID engine's network) which provides for uniform display and printing. All online-equivalent dynamic interactivity and linking amongst the compiled document and optional data files is preserved and available offline. Additionally, when the .PID is accessed online, any embedded online-only dynamic interactivity and linking functionality becomes active (e.g., live data and URL links, access and usage metrics and tracking, electronic communications). The .PID has widespread utility in any industry where the .PDF is prevalent, including academic, financial, and scientific research, for any print medium, including magazine and books, and whenever it's desired to make online publishing portable.

1. A system for creating a portable interactice document comprising at least one processor coupled to a computer memory, the computer memory having executable instructions stored thereon that when executed cause the processor to create an instance of a portable interactive document, display a plurality of tool for users to add interactive elements into the portable intractive document, and to save the instance of the porable interactive in the computer memory.
